(19) United States
(12) Patent Application Publication
(10) Pub. No.: US 2006/0175397 A1
(43) Pub. Date: Aug. 10, 2006

(54) System and method of reporting lost or stolen cards

(76) Inventor: Manoj Tewari, Rego Park, NY (US)

Correspondence Address: LITMAN LAW OFFICES, LTD, PO BOX 15035, CRYSTAL CITY STATION, ARLINGTON, VA, 22215, US

(21) Appl. No.: 11/334,408

(22) Filed: Jan. 19, 2006

Related U.S. Application Data
(60) Provisional application No. 60/651,517, filed on Feb. 10, 2005.

(51) Int. Cl. G06K 5/00

(52) U.S. Cl. 235/380

(57) ABSTRACT

The system and method of reporting lost or stolen cards allows an individual to use one website to report multiple lost or stolen cards. A user enters lost card information on a card-reporting website. The information for the card is then sent through an e-mail to a card-issuing company. Once the e-mail has been received, a confirmation is sent to the card-reporting website's server. A confirmation e-mail and number are then transmitted through an e-mail to the user, notifying the user that the card-issuing company has received their information. The user is then prompted to enter information for additional cards that will be sent to an additional card-issuing company, and the process is repeated.

### CROSS-REFERENCE TO RELATED APPLICATION

This application claims the benefit of U.S. Provisional Patent Application Ser. No. 60/651,517, filed Feb. 10, 2005.

### BACKGROUND OF THE INVENTION

1. Field of the Invention

The present invention relates to systems for reporting lost or stolen articles, and particularly to a system and method of reporting multiple lost or stolen cards utilizing a single website.

2. Description of the Related Art

When an individual loses his or her wallet, with numerous credit, debit and other cards in it, or has his or her wallet stolen, it becomes quite inconvenient to report all of the lost cards to the respective card-issuing companies. Each card requires a call, e-mail or website visit to each company involved. Often with lost cards, and especially with stolen cards, speed in reporting the loss is very important in preventing against unauthorized use of the cards.

While many card-issuing companies have a specific number to call to report the loss or a website to input lost card information, if the individual is dealing with multiple lost cards, finding each website or phone number for each company may be time-consuming and frustrating. In addition, some individuals may be wary of sending personal information multiple times over the Internet to multiple sites, giving online hackers and thieves more of an opportunity to obtain personal cardholder information.

Accordingly, there is a need for a single secure website that allows a user to send out lost card information to numerous card-issuing companies, and to also notify the user that the companies have received that information. Thus, a system and method of reporting lost or stolen cards solving the aforementioned problems is desired.

### SUMMARY OF THE INVENTION

The system and method of reporting lost or stolen cards allows an individual to use one website to report multiple lost or stolen cards. The lost card information is then transmitted to each card-issuing company, and the user is sent a confirmation e-mail and number notifying the user that the appropriate information was sent to the corresponding company.

A user enters lost card information through a client computer connected to a network, such as the Internet. The lost card information is submitted on a card-reporting website administered by a card-reporting server. The user is provided the option of entering information about a lost card into entry boxes provided on the website.

Once the user has entered all the information relevant to the lost or stolen card, the information for the card is sent through an e-mail over the network. The set of information related to the particular card is transmitted to the appropriate card-issuing merchant through the company's e-mail server. After the card-reporting server receives confirmation that the e-mail was delivered to the specific card-issuing merchant, then a confirmation e-mail is transmitted to the user, informing the user that the card information was delivered. A confirmation number is included as part of the confirmation e-mail. If more cards are to be reported, the user inputs another set of information for another card and the process repeats. The user is therefore able to report the loss of multiple credit, debit or other cards through the one card-reporting website.

These and other features of the present invention will become readily apparent upon further review of the following specification and drawings.

### BRIEF DESCRIPTION OF THE DRAWINGS

FIG. 1 is a block diagram of a system for reporting lost or stolen cards according to the present invention.

FIG. 2 is a perspective view of a personal computer used with the system for reporting lost or stolen cards according to the present invention.

FIG. 3 is a front view of a computer display with a cardholder information entry box of the system for reporting lost or stolen cards according to the present invention.

FIG. 4 is a front view of a confirmation e-mail of the system for reporting lost or stolen cards according to the present invention.

FIG. 5 is a flow chart of the system for reporting lost or stolen cards according to the present invention.

Similar reference characters denote corresponding features consistently throughout the attached drawings.

### DETAILED DESCRIPTION OF THE PREFERRED EMBODIMENT

The present invention is a system and method, implemented through a computer network, for reporting lost or stolen cards. A user enters lost card information to a website, whose server sends an e-mail communication to the appropriate card-issuing company, including credit card companies, financial institutions, and any other merchant that provides cards to its customers. Once a confirmation is received by the first website that the information was successfully delivered to the card website, a confirmation e-mail is then transmitted to the user informing the user that the information was delivered. The user is then prompted to enter information for additional cards if needed and the above process repeats for each additional card.

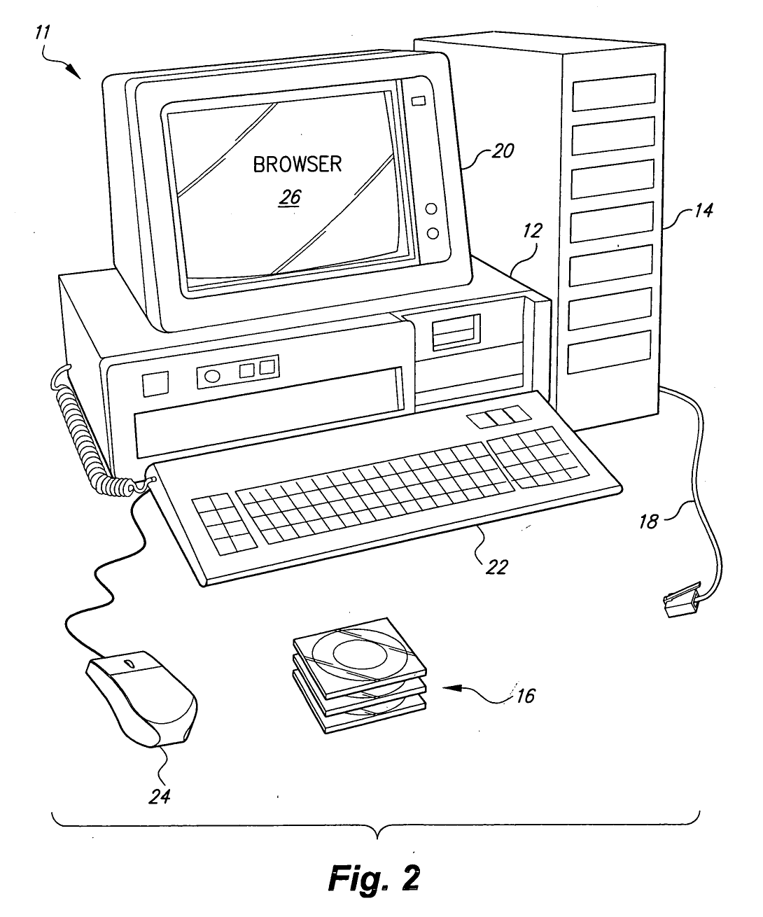

The system is designed to operate on one or more computers. While mainframes or minicomputers may be used, the system performs adequately using personal computers systems. While the details on the computer system may vary and still be within the scope of the claimed invention, FIG. 2 shows a typical personal computer system for carrying out the present invention.

The personal computer system is a conventional system that includes a personal computer 11 having a microprocessor disposed in a housing 12, the microprocessor including a central processing unit (CPU), a sequencer and an arithmetic logic unit (ALU), connected by a bus or buses to an area of main memory for executing program code under the direction of the microprocessor, main memory including read-only memory (ROM) and random access memory (RAM). The personal computer 11 also has a memory storage unit 14. It will be understood that the term memory storage unit 14 refers to a device or means for storing and retrieving data or program code on any computer readable medium, and includes, for example, a compact disk 16 or compact disk drive, a hard disk drive, a floppy drive or floppy disk, a digital video disk (DVD) driver or DVD disk, a ZIP drive or ZIP disk, magnetic tape and any other magnetic medium, punchcards, paper tape, memory chips, or any other medium from which a computer can read and store data. The personal computer 11 also includes a data communications device, such as a modem or other means for connecting to a network, such an Ethernet connection, ISDN, DSL, or other device for connecting to a network 100, through a cable 18 or other linking arrangement. The personal computer system also includes peripheral devices, such as a display monitor 20 and one or more data input devices, such as a keyboard 22 or a mouse 24.

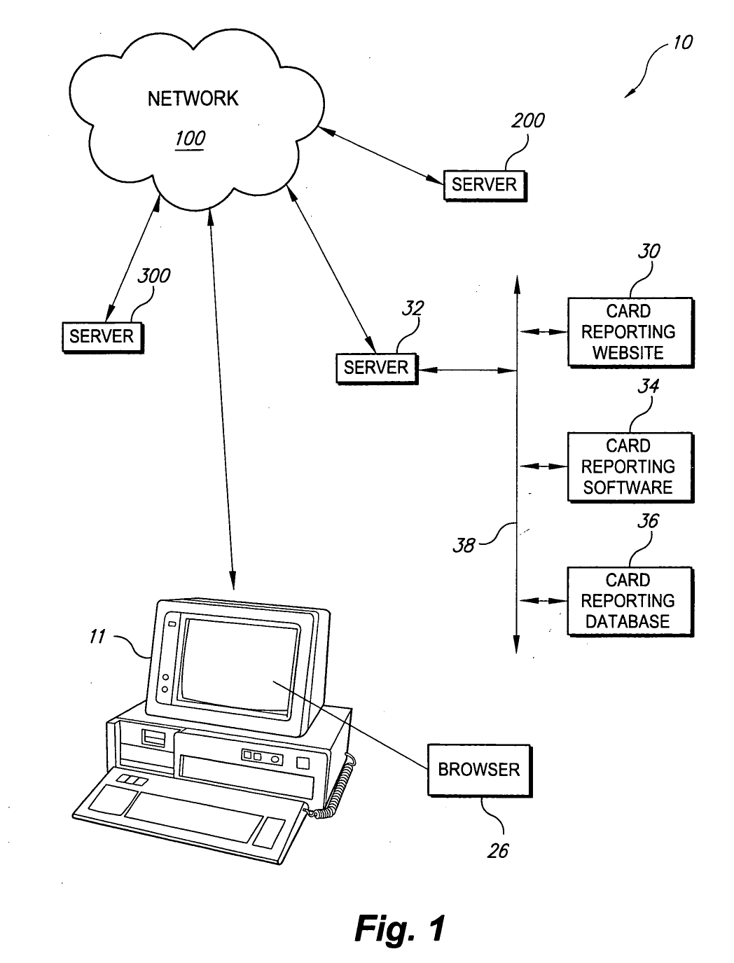

The client personal computer 11 is equipped with a web browser 26 (referred to schematically in FIG. 1), such as Netscape Navigator®, Internet Explorer, made by Microsoft®, or other browser software executing in main memory, while server computers will be equipped with web server software capable of delivering web pages in hypertext markup language (HTML) to client computers using hypertext transfer protocol (HTTP).

FIG. 1 shows a representative system 10 in which the present invention operates, where a client computer 11 may interconnect via a browser 26 with a card-reporting website 30 over a network 100. While a standard desktop computer is shown, the client computer 11 may be any type of apparatus that is able to connect over a network, for example a laptop computer, a cellular phone, a personal digital assistant (PDA), a BlackBerry®, an embedded device, a smart phone, etc., that may be connected over a network 100.

A user accesses and communicates over the network 100 through the browser 26 supported by the client computer 10. The card-reporting website 30 is administered by a card-reporting server 32, card-reporting software 34, and a card-reporting database 36. The card-reporting website 32, card-reporting software 34, and the card-reporting database 36 are interconnected via a communication bus 38. The card-reporting website 30 is a collection of files stored on the server 32 that is connected to the network 100. The network 100 can be the World Wide Web, which is a collection of websites whose servers are interconnected through the Internet.

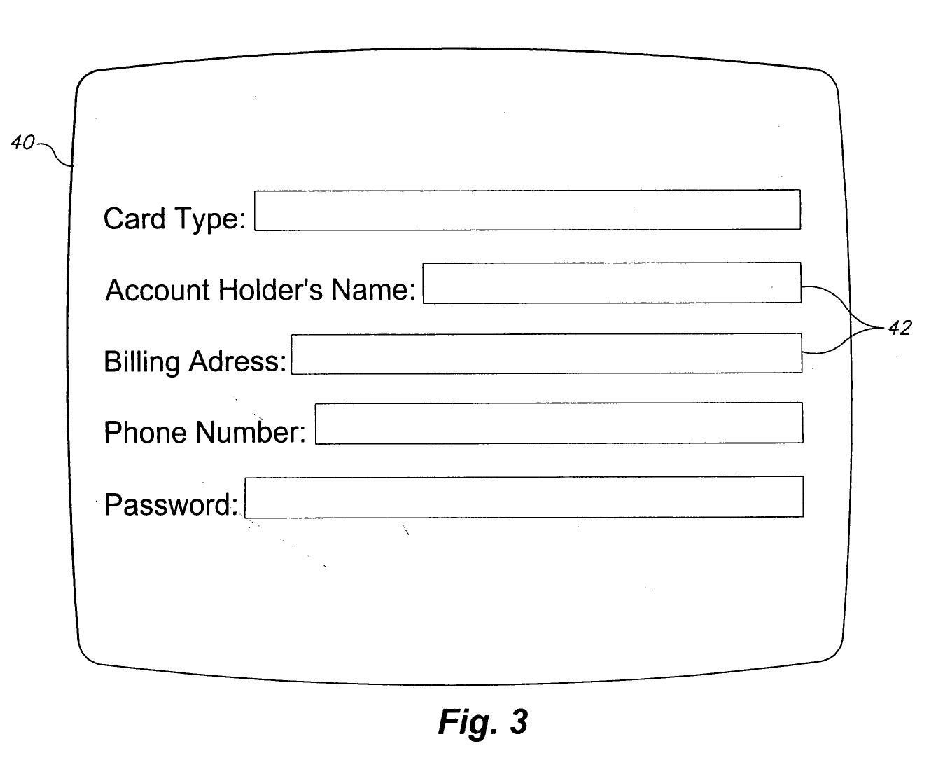

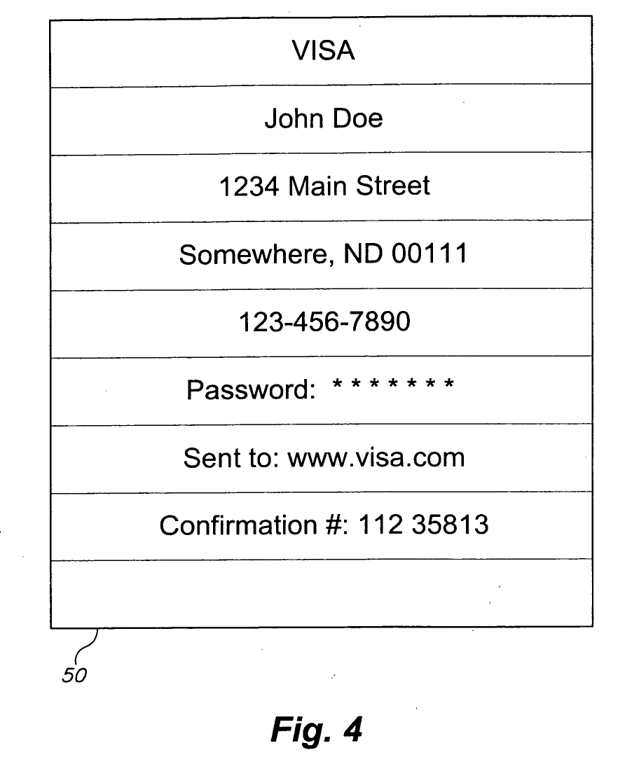

The user accesses the card-reporting website 30, which is connected to the network 100 by the card-reporting server 32. The user enters information in an entry box 40, shown in FIG. 3, about a lost or stolen card on the card-reporting website 30. The card may be a credit card, debit card, store card, or any other type of merchant-related card associated with an individual account. The website 30 provides the user the option of entry boxes 40 specific to the card that the user is reporting. The fields 42 of the entry box 40 may be specified by each card company and may include, for example, the type of card lost, the primary account holder's name, the billing address, a phone number, a password, or any other field required by each credit card company. The card-reporting software 34 causes the user information to be stored on the database 36. Once the user has entered all the information relevant to the lost or stolen card, the information for that card is sent through an e-mail or other relaying means over the network 100. The set of information related to the particular card is sent to the appropriate card-issuing merchant through the company's e-mail server 200. The card-reporting server 32 thereafter receives confirmation through a delivery receipt, typical of numerous e-mail programs, that the e-mail was received by the specific merchant server 200. The card-reporting server 32 sends a confirmation e-mail 50, as shown in FIG. 4, to the client computer 10 that the information inputted into the entry boxes 40 was received by the merchant server 200. The confirmation e-mail 50 displays the information the user originally inputted into the client computer 11, as well as a confirmation number for the user's records.

The user then has the option of entering additional information about other lost or stolen cards. The additional information for the new card is sent through an e-mail or other relaying means over the network 100 to the appropriate card-issuing merchant through that particular company's e-mail server 300. The confirmation process described above is then implemented for that particular card. Thus, the user is able to report the loss of multiple credit, debit or other cards through the one card-reporting website 30 and the lost card information is thereafter transmitted to multiple card companies.

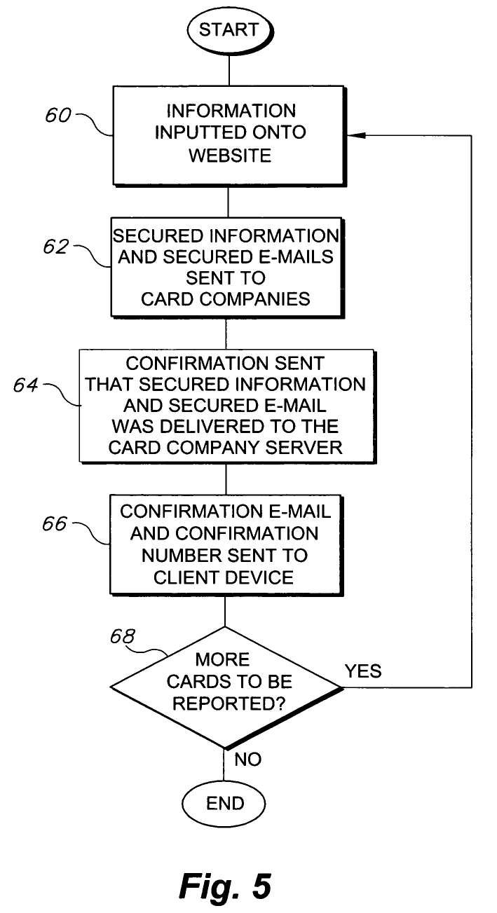

FIG. 5 is a flow chart of the steps involved in the method for reporting lost or stolen cards as implemented by the card-reporting system 10. As indicated at 60, information is first inputted onto a card-reporting website 30 by a user through a user interface at a client computer 11. The card-reporting server 32 receives the information. The card-reporting server 32 then sends this secured information entered as a secured e-mail or other communicative means over the network 100 to a first card company or merchant server 200 at 62. At 64, a confirmation is sent to the card-reporting server 32 that the appropriate secured e-mail has been delivered to the merchant server 200. Responsive to receiving the e-mail confirmation, at 66, the card-reporting server 32 sends a notification communication over the network 100 to the client computer 11. The notification is generally an e-mail, such as that in FIG. 4, and additionally includes a confirmation number for the user's reference. At 68, the user is asked whether he needs to enter information for additional cards. If yes, the user is prompted to add the additional information for the new card and the process repeats, with the new information being sent to the second merchant server 300. If no more cards need to be reported, then the process is finished.

It is to be understood that the present invention is not limited to the embodiment described above, but encompasses any and all embodiments within the scope of the following claims.

I claim:

1. A method of reporting a lost or stolen card, comprising the steps of:
receiving input, the input being generated by a user through a user interface at a client device;
after receiving input from the user, generating at least one communication at a card-reporting server;
transmitting said communication over a network to a merchant server;
receiving a confirmation at the card-reporting server that said communication has been delivered to the merchant server; and,
after receiving said confirmation, sending a notification communication to the client device.

2. The method of reporting a lost or stolen card as recited in claim 1, wherein said step of receiving input includes inputting of identification information relating to a card.

3. The method of reporting a lost or stolen card as recited in claim 2, wherein said step of receiving input includes inputting of identification information related to the user.

4. The method of reporting a lost or stolen card as recited in claim 1, further comprising the step of querying the user as to whether further information is to be input and transmitted, following said step of sending notification to said client device.

5. The method of reporting a lost or stolen card as recited in claim 4, further comprising the step of restarting said method of reporting a lost or stolen card if said user provides an affirmative answer to said step of querying the user.

6. A method of reporting a lost or stolen card, comprising the steps of:
receiving a first input, the first input being generated by a user through a user interface at a client device;
after receiving the first input from the user, generating a first communication at a card-reporting server;
transmitting said first communication over a network to a first merchant server;
receiving a first confirmation at the card-reporting server that the first communication has been received at the first merchant server;
after receiving said first confirmation, sending a first notification communication to the client device;
receiving a second input, the second input being generated by the user through the user interface at the client device;
after receiving the second input from the user, generating a second communication at a card-reporting server;
transmitting said second communication over the network to a second merchant server;
receiving a second confirmation at the card-reporting server that the second communication has been received at the second merchant server; and
after receiving said second confirmation, sending a second notification communication to the client device.

7. The method of reporting a lost or stolen card as recited in claim 6, further comprising the step of querying the user as to whether further information is to be input and transmitted, following said step of sending said second notification to said client device.

8. The method of reporting a lost or stolen card as recited in claim 7, further comprising the step of restarting said method of reporting a lost or stolen card if said user provides an affirmative answer to said step of querying the user.

9. A system for reporting a lost or stolen card, comprising:
a data entry and display system;
a card reporting server linked to said data entry and display system via a data network; and,
at least one merchant computer linked to said card reporting server via said data network, wherein a user may input card and identification related information to said data entry and display system when said card is lost or stolen, said card and identification related information being transmitted to said card reporting server via said network, said card reporting server transmitting said card and identification data to said at least one merchant computer, said at least one merchant computer transmitting an acknowledgement of receipt to said card related server, said card related server forwarding said acknowledgment of receipt to said data entry and display system for receipt by the user.
